(19) United States
(12) Patent Application Publication
(10) Pub. No.: US 2001/0044016 A1
(43) Pub. Date: Nov. 22, 2001

(54) Continuous method of making four-tapered edge gypsum board and the gypsum board made therefrom

(76) Inventor: Edward W. Watras, Huntington, NY (US)

Correspondence Address: James W. Badie, Esq., Stoll, Miskin, Hoffman & Badie, The Empire State Building, 350 Fifth Avenue, Suite 6110, New York, NY, 10118, US

(21) Appl. No.: 09/882,726

(22) Filed: Jun. 15, 2001

Related U.S. Application Data
(60) Provisional application No. 60/271,020, filed on Feb. 22, 2001.

(51) Int. Cl. B32B 23/02; B32B 31/14; D04H 1/00

(52) U.S. Cl. 428/292.1; 428/192; 156/45

(57) ABSTRACT

A method is provided for continuous production of gypsum boards which comprises forming a laminate of gypsum slurry between a facing paper and a backing paper and continuously forming a longitudinal recess along the side edges of the laminate surface, and a lateral recess at spaced intervals on the laminate surface thereby producing a four-tapered edge gypsum board which is uniquely suitable as a material of construction in the building industry.

### RELATED APPLICATIONS

This application is related to applicant's provisional patent application Ser. No. 06/271,020, filed Feb. 22, 2001, entitled Dry Wall Panel Construction Method and Product as to which priority is claimed.

### FIELD OF THE INVENTION

The present invention relates to the manufacture of gypsum boards and is particularly related to the manufacture of tapered gypsum boards suitable for making dry wall panels. In one specific aspect, the present invention relates to a continuous method of production of four-tapered edge gypsum wallboard and to the gypsum wallboard made therefrom.

### BACKGROUND OF THE INVENTION

Gypsum board has been widely used in the building industry and its commercial production has therefore received considerable attention in the prior art. As mentioned in U.S. Pat. No. 5,198,052 issued Mar. 30, 1993 to Mohammed H. Ali, gypsum board is a laminate structure comprising a gypsum core sandwiched between a face paper and a back paper. The gypsum board is made as a continuous sheet by a continuous method on a conveyor belt with associated rollers. High quality bond between the gypsum core and the papers between which the core is laminated is of paramount importance to the integrity of the board. Accordingly, numerous factors must be considered during the method of production of gypsum boards. These include the flow rate of the gypsum slurry, thickness of the slurry, the speed of the conveyor belt, the residence time required for setting, i.e., hardening of the gypsum slurry, and the time interval between successive cutting of the hardened gypsum sheet into individual wallboards.

In order to utilize the gypsum wallboards in building construction such as in the erection of walls and ceilings of a structure, gypsum boards which are tapered along their longitudinal side edges have been widely used. However, it has been found and observed that the use of gypsum wallboard with tapered edges on all four sides of the finished wallboard, as compared to wallboard with tapered edges only on its two longitudinal sides result in a more attractive and monolithic wall appearance. Typically, during a building construction one or more layers of gypsum boards are secured to one or more frames (e.g., studs, joints) to form the surfaces of the walls or ceilings. The side edges of the board are butted together over the frame and the board is then secured (e.g., nailed, screwed) to the frame, and reinforcing joint tape and joint compound are then used to cover the butt joints. Often, the use of joint tape and joint compounds results in formation of unsightly ridges on the wall or ceiling. The use of gypsum board with tapered edges, which normally follow the contour of the edge of the belt, reduces the thickness of the board at the side edges by providing a depression which can be filled with the joint compound to produce a smooth surface and provide a depression or a groove for the joint compound, thus eliminating the formation of unsightly ridges. Moreover, there are significant labor savings in the taping, smoothing and finishing of tapered joints as compared with doing the same to untapered joints.

It has heretofore been difficult to produce gypsum board with four-sided tapered edges notwithstanding the building industry's recognition of their advantages. The aforementioned patent to Ali describes past but unsuccessful attempts to produce gypsum boards with tapered edges areas across the width of the board at desired length intervals. This method involves placing cross tapering belts or slats between the board and the main conveyor belt during production of the board. The Ali patent also describes a method of forming a four tapered edge gypsum board on a continuous production line before the gypsum sets or cures. Referring to its FIG. 6, this patent shows a tapered mold surface which extends laterally across the conveyor belt, and in FIG. 5, the patent shows the formation of tapered edges along the longitudinal direction of the belt. Other means are also disclosed for forming the tapers which involves using a cross plate (in FIG. 6) under roller 80 with a raised section 82 as illustrated in FIG. 7. In FIG. 8, the Ali patent shows a dual continuous belt with a lower belt containing a raised portion 87.

The production of four tapered edge gypsum board is also described in an earlier patent, i.e., U.S. Pat. No. 2,246,987 issued Jun. 24, 1941 to C. K. Roos. In the method described by Roos forming bars are transversely disposed at certain spaced intervals along the longitudinal path of the conveyor belt carrying the plastic mass in order to form transverse recesses in one surface of the plastic mass at selected intervals.

Notwithstanding the methods described in the aforementioned patents of Ali and Roos, and in other prior art patents, so far as it known there is still no commercially viable method of continuous production of four-tapered edge gypsum board, and the dire need for such method continues in the building industry.

Accordingly, it is an object of the present invention to provide a method for continuous production of four-tapered edge gypsum board.

It is another object of the present invention to provide a method for continuous production of four tapered edge gypsum board for use as wallboard in the construction industry which eliminates unsightly ridges in the wall.

It is a further object of the present invention to provide a method to produce four-tapered edge gypsum board by a continuous method which is commercially viable to satisfy the demand of the construction industry.

It is also an object of the present invention to provide four-tapered edge gypsum board wherein the longitudinal and lateral tapers are aligned in mating relationship at 45-degree angles in order to further assure against the formation of unsightly ridges at the joints.

The foregoing and other features of the present invention will be more fully appreciated from the following description of the invention and drawings all of which form parts of this application.

### SUMMARY OF THE INVENTION

A method is provided for continuous production of four-tapered edge gypsum board from a gypsum slurry for use in construction of walls and ceilings in the building industry. The method comprises a method for continuous production of four-tapered edge gypsum board comprising (a) advancing a face paper toward a continuous moving belt;(b) introducing a first stream of gypsum slurry onto said advancing face paper; (c) introducing a second stream of gypsum slurry onto said advancing first stream and advancing said face paper coated with the combined first and second gypsum streams; (d) introducing a third stream of gypsum slurry onto said face paper coated with said combined first and second gypsum streams followed by advancing a backing paper thereby forming a laminate of said combined first, second and third streams of gypsum slurry, between said face paper and said backing paper; (e) continuously advancing a tape strip in contact with the surface of said face paper to thereby form a recess on said face paper along each longitudinal edge thereof; (f) forming a lateral recess at spaced intervals on the surface of said face paper; (g) continuing to advance the gypsum slurry sandwiched between said face paper and said backing paper with the longitudinal recesses and lateral recesses formed thereon until the gypsum slurry is cured to a hard sheet of gypsum board, and (h) cutting individual pieces of gypsum boards at predetermined distance intervals as said sheet advances along said conveyor belt.

The four-tapered gypsum board is uniquely suited for forming walls and ceilings with smooth monolithic finished appearance without unsightly ridges at the joints.

### BRIEF DESCRIPTION OF THE DRAWINGS

In the drawings, wherein like reference numerals are used to designate like parts:

FIG. 1 is a schematic, partly perspective view of the method of continuous production of four-tapered edge gypsum board according to the present invention;

FIG. 2 is a top, partly perspective view of a gypsum board having four-tapered edges formed according to the present invention;

FIG. 3 is a sectional view taken along the line 3-3 in FIG. 2,

FIG. 4 is a schematic, partly perspective view of the taper forming portion of the conveyor belt used in carrying out the method of this invention;

FIG. 5 is a sectional view taken along the line 5-5 in FIG. 4;

FIG. 6 is a sectional view taken along the line 6-6 of FIG. 5; and

FIG. 7 is a view of a part of the four-tapered edge gypsum board showing the 45-degree angle of tapers of the longitudinal as well as lateral edges of the board;

FIG. 8 is a schematic view of the tapered edges of adjacent gypsum boards made according to the present invention, with reinforcing tape and joint compound; and

FIG. 9 is a view similar to FIG. 8 showing standard prior art gypsum board with a butt joints finish.

### DETAILED DESCRIPTION OF THE INVENTION

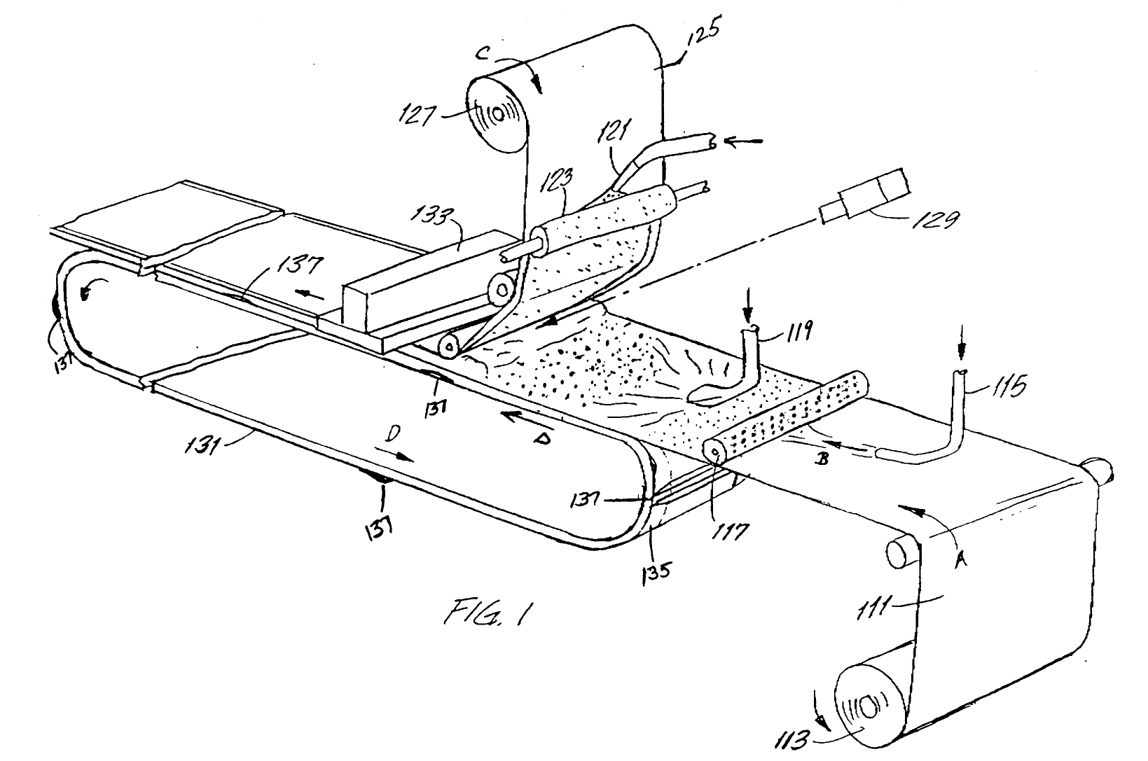

The method of this invention maybe described by reference to FIG. 1 which shows the equipment used to carry out the method. A sheet of the face paper 111 is unwound from the master roll 113 which may be driven by a motor (not shown) as the facing paper advances in the direction of the arrow A. A first stream of gypsum slurry is introduced via conduit 115 onto the facing paper 111 (see arrow B) and is spread thereover by the spread roller 117 thereby forming a thin layer of gypsum slurry over the face paper. This initial stream is preferably uniform and smooth in texture so as form a uniform smooth surface in contact with the face paper after the gypsum slurry is subsequently cured. As the face paper further advances in the direction of arrow B, a second stream of gypsum slurry which constitutes the bulk of the slurry is introduced onto the first stream via conduit 119, followed by a third stream of gypsum slurry which is introduced via conduit 121 onto a second spreading roller 123 and spread over the combined first and second streams of gypsum slurries. The gypsum slurry streams introduced via conduits 115 and 121 are denser than the gypsum slurry introduced via conduit 119. Backing paper 125 is continuously unwound from the backing paper master roll 127 and advanced in the direction of the arrow C, thus resulting in the formation of a laminate of gypsum slurry, still in uncured state, between the face paper 111 and backing paper 125.

In operation, and as matter of common experience, sometimes there may be a tendency for the combined first and second stream of the gypsum slurry to build up or back up near the point where the third stream is introduced. Therefore, in order to control the thickness and/or quantity of flow of the gypsum slurry and avoid slurry back up at this point, means is provided which can sense the undesired slurry back-up by detecting the thickness of coating of the slurry and automatically adjusting this thickness to facilitate the flow and advance of the gypsum slurry. The sensing means used herein is preferably a laser 129, but may be any other similar means designed to monitor the thickness and/or build up of the gypsum slurry.

The quantity of the third slurry stream, as well as the consistency, texture and smoothness of this stream are selected with a view to forming a uniform and smooth layer in contact with the backing paper 125 after the gypsum board is cured. In this manner, the resulting gypsum board, which is a laminate of gypsum after curing, will have uniformly smooth surfaces in contact with the face paper as well as the backing paper. Such smooth surfaces enhance the appearance of the walls and ceilings made with such gypsum boards.

Referring back to FIG. 1, after third stream of gypsum slurry has been introduced, the combined slurry, which is sandwiched between the face paper 111 and the backing paper 125 is passed over a conveyor belt 131 moving in direction of the arrow D. The slurry laminate sandwiched between the face paper 111 and backing paper 125 is then contacted gently by a compressor bar 133 disposed above the laminate and activated, preferably by sufficient weight but may be electrically activated, against the surface of the laminate to a predetermined desired thickness. Also shown in FIG. 1, is a continuous strip of tape 135 passing under the laminated slurry, in the longitudinal direction along both edges of the laminate, pressed gently against the face paper such as to form longitudinal recesses, i.e., tapers along the longitudinal edges of the laminate. The conveyor belt 131 is also provided with a plurality of spaced apart cross bars 137, spaced at different intervals, preferably at equal predetermined distances, adapted to contact the moving slurry laminate thus exerting slight pressure and forming a lateral taper, at given intervals along the length of the conveyor belt 131. As the laminate of the gypsum slurry advances further, the slurry will cure and harden, i.e., it sets after a predetermined time, thus forming a gypsum board having the desired four-tapered edge construction.

In carrying the method of this invention the type of gypsum used, such as calcined gypsum, the amount of water in the gypsum slurry, i.e., its degree of hydration, the time required to dry the gypsum slurry before it sets and the length of the conveyor belt are significant parameters which are discussed extensively in the prior art. The aforementioned Ali patent and Roos patent are typical of such prior art patents to which reference may be made for guidance in selecting these parameters. It must be emphasized, however, that the method of this invention it is intended to form a four-tapered edge gypsum board with mating angular edges and smooth textured surfaces which enhance the appearance and finish of walls and ceilings using such gypsum boards.

A finished gypsum board 200 with four-tapered mating edges is shown in FIG. 2 having board surface 201, longitudinal edge 203 and lateral edge 205 wherein these edges are tapered identically in all relevant dimensions (e.g., angle of taper, depth of taper, width of taper) such that they meet at a 45-degree angle as shown in 207.

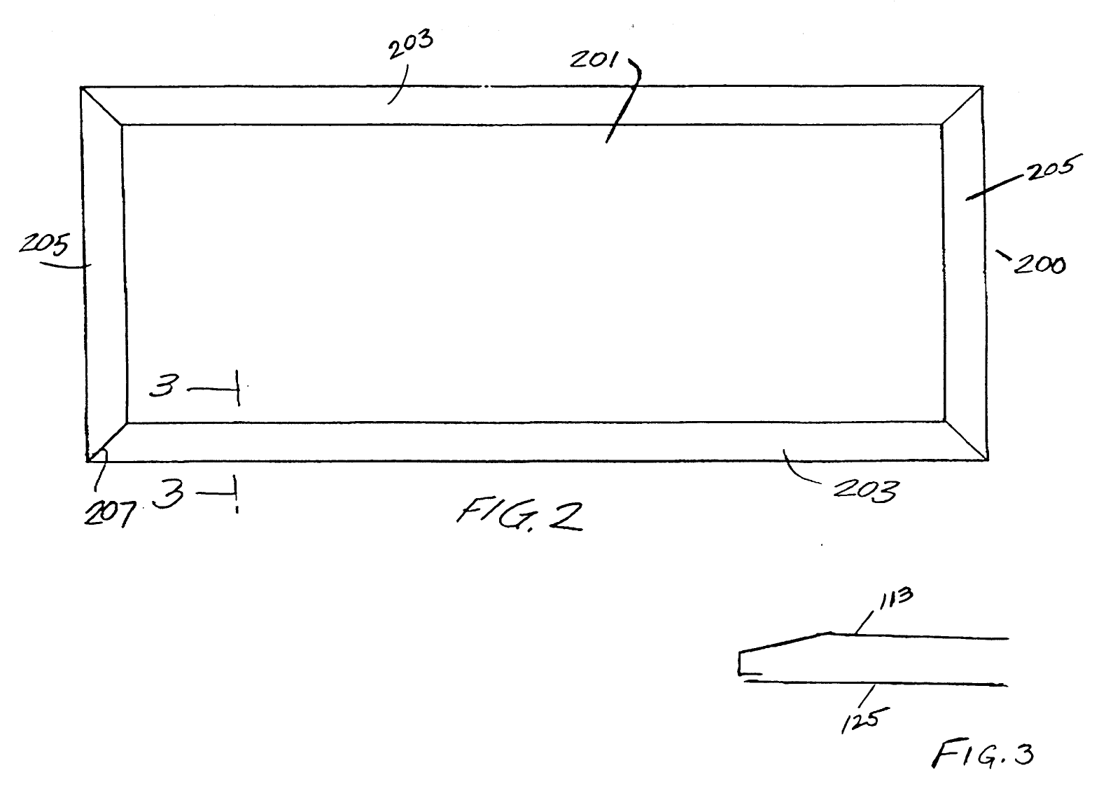

FIG. 3 shows the gypsum slurry sandwiched between the facing paper 111 and backing paper 125. As in the prior art methods, the gypsum board is made face down and before starting the method, the face paper is folded up along the two longitudinal edges and folded over on top of the slurry along these edges.

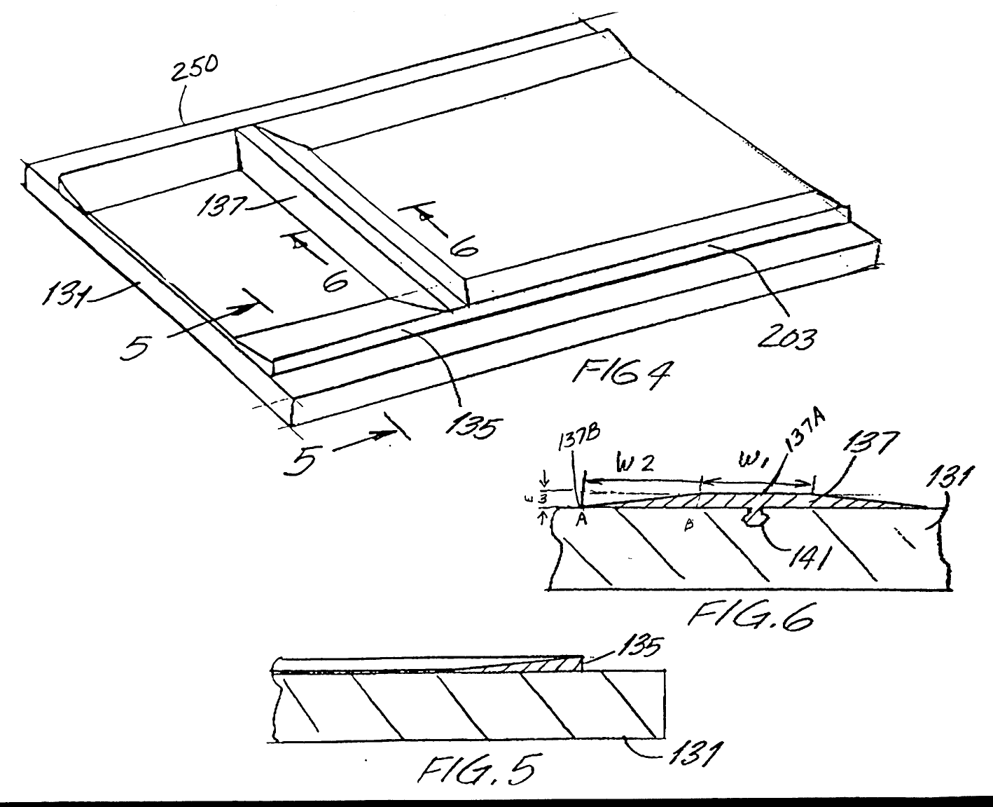

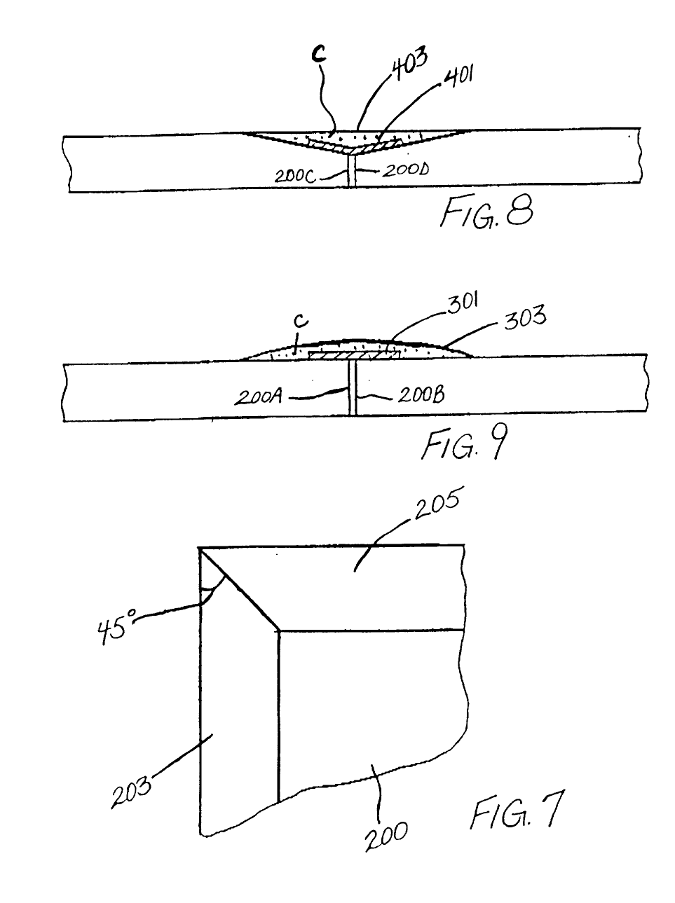

The formation of the longitudinal tapers as well as the lateral (transverse) tapers are further illustrated in FIGS. 4-6. Referring to these drawings, as the gypsum board 200 travels along the conveyor belt 131, it is contacted by the continuous strip of tape 135 which forms the longitudinal recess or taper 203. The lateral or transverse recesses or tapers are formed on the surface of the advancing board by the use of a series of equidistantly spaced cross bars such as the cross bar 137. Each cross bar is secured to the conveyor belt 131 by means of a pin 141 although any other suitable means may be used to secure the cross bar to the conveyor belt. The tapers on the longitudinal and lateral edges of the gypsum board are formed at 45-degree angles relative to the direction of travel of the conveyor belt. Thus each piece of gypsum board 200 is formed with mating longitudinal and lateral edges, having a 45 degree mating angle as shown in FIG. 7.

The cross bar 137 is shaped with a raised crown portion 137a having a width W1 and a width W2 from the top of the crown portion to the tapered end 137B which terminates at the surface of the conveyor belt 131, with W3 defining the width between the top surface of the conveyor belt at point A to the the point B at the end of the crown portion. These dimensions are designed so that the cross bar 137 can produce a lateral recess on the gypsum board upon minimal contact and pressure on the board's surface.

The advantages of the method of this invention may be further realized by reference to FIGS. 8 and 9 comparing how the joints of the gypsum board are joined together during construction of a wall or a ceiling. In FIG. 9, which represents a standard finish, the standard square cut butt ends 200A and 200B of the gypsum boards are reinforced with a paper reinforcing tape 301 using a joint compoiund C resulting in the formation of an unsightly ridge or bulge 303. By contrast, when the ends 200C, 200D of tapered gypsum boards, formed in accordance with the method of this invention, are aligned, reinfornced by the tape and joint compound C, the finish is smooth and flat as in 403 without unsightly ridges thus resulting in a smooth monolithic wall.

Although the present invention has been described with certain degrees of particularity, it is apparent to one skilled in the art that several changes or modifications may be made in this method which are obvious from the foregoing detailed description and the drawings.

1. A method for continuous production of four-tapered edge gypsum board comprising:
(a) advancing a face paper toward a continuous moving belt,
(b) introducing a first stream of gypsum slurry onto said advancing face paper,
(c) introducing a second stream of gypsum slurry onto said advancing first stream and advancing said face paper coated with the combined first and second gypsum streams,
(d) advancing backing paper in the same direction as of said face paper and introducing a third stream of gypsum slurry to combine with said first and second gypsum streams thereby forming a laminate of said combined first, second and third streams of gypsum slurry, between said face paper and said backing paper,
(e) continuously advancing a tape strip in contact with the surface of said face paper to thereby form a recess on said face paper along each longitudinal edge thereof,
(f) forming a lateral recess at spaced intervals on the surface of said face paper,
(g) continuing to advance the gypsum slurry sandwiched between said face paper and said backing paper with the longitudinal recesses and lateral recesses formed thereon until the gypsum slurry is cured to a hard sheet of gypsum board, and
(h) cutting individual pieces of gypsum boards at predetermined distance intervals as said sheet advances along said conveyor belt.

2. A method as in claim 1 wherein each lateral recess is formed by a crossbar disposed below said moving gypsum board.

3. A method as in claim 2 wherein each crossbar comprises a pin member secured to said moving belt.

4. A method as in claim 3 wherein a plurality of crossbars are secured at substantially equal distance above said moving belt.

5. A method as in claim 1 wherein each of said longitudinal recesses and each of said lateral recesses are formed at about 45 degrees relative to direction of travel of the conveyor belt.

6. A method as in claim 2 wherein each of said longitudinal recesses and each of said lateral recesses are formed at about 45 degrees relative to direction of travel of the conveyor belt.

7. A method as in claim 3 wherein each of said longitudinal recesses and each of said lateral recesses are formed at about 45 degrees relative to direction of travel of the conveyor belt.

8. A method as in claim 4 wherein each of said longitudinal recesses and each of said lateral recesses are formed at about 45 degrees relative to direction of travel of the conveyor belt.

9. A method as in claims 1, 2, 3, 4, 5, 6, 7 or 8 further including a means to monitor and adjust the quantity of said combined first and second stream of gypsum slurry.

10. A method for continuous production of four-tapered edge gypsum board comprising:
(a) advancing a face paper toward a continuous moving belt,
(b) introducing a first stream of gypsum slurry onto said advancing face paper in an amount sufficient to form a relatively thin first coating of gypsum slurry on said face paper,
(c) spreading said first stream over the said face paper to form said first coating,
(d) introducing a second stream of gypsum slurry onto said first coating, said second stream constituting the major amount of the gypsum slurry,
(e) introducing a third stream of gypsum slurry onto said combined first and second stream and spreading said third stream so as to form a relatively thin second coating of gypsum slurry,
(f) advancing the resulting slurry laminate sandwiched between said facing paper and said backing paper and pressing said laminate to a predetermined thickness,
(g) continuously advancing a tape strip in contact with said face paper to thereby form a recess along each longitudinal edge of said face paper,
(h) forming lateral recesses at spaced intervals on said face paper,
(i) continuously advancing the gypsum slurry sandwiched between said face paper and said back paper until said gypsum slurry is cured to a hard sheet of gypsum board, and
(j) cutting individual pieces of gypsum boards at predetermined distance intervals as said sheet advances along said conveyor belt.

11. A method as in claim 10 wherein each lateral recess is formed by a crossbar disposed above said moving gypsum board.

12. A method as in claim 11 wherein each crossbar comprises a pin member secured to said moving belt.

13. A method as in claim 12 wherein a plurality of crossbars are secured at substantially equal distance above said moving belt.

14. A method as in claim 10 wherein each of said longitudinal recesses and each of said lateral recesses are formed at about 45 degrees relative to direction of travel of the conveyor belt.

15. A method as in claim 11 wherein each of said longitudinal recesses and each of said lateral recesses are formed at about 45 degrees relative to direction of travel of the conveyor belt.

16. A method as in claim 12 wherein each of said longitudinal recesses and each of said lateral recesses are formed at about 45 degrees relative to direction of travel of the conveyor belt.

17. A method as in claim 13 wherein each of said longitudinal recesses and each of said lateral recesses are formed at about 45 degrees relative to direction of travel of the conveyor belt.

18. A method as in claims 10, 11, 12, 13, 14, 15, 16 or 17 further including a means to monitor and adjust the quantity of said combined first and second stream of gypsum slurry.

19. A gypsum board comprising a face paper defining one surface of said board, a backing paper defining an opposed surface of said board and four side edges joining said surfaces, wherein said surfaces are tapered at all said four edges to form a tapered edge at each side which mates with the tapered edge adjacent thereto.

20. A gypsum board as in claim 19 wherein each of said edges is tapered at approximately 45 degrees.

21. A gypsum board as in claim 20 formed by a method comprising:
(a) advancing a face paper toward a continuous moving belt,
(b) introducing a first stream of gypsum slurry onto said advancing face paper,
(c) introducing a second stream of gypsum slurry onto said advancing first stream and advancing said face paper coated with the combined first and second gypsum streams,
(d) advancing backing paper in the same direction as of said face paper and introducing a third stream of gypsum slurry to combine with said first and second gypsum streams thereby forming a laminate of said combined first, second and third streams of gypsum slurry, between said face paper and said backing paper,
(e) continuously advancing a tape strip in contact with the surface of said face paper to thereby form a recess on said face paper along each longitudinal edge thereof,
(f) forming a lateral recess at spaced intervals on the surface of said face paper,
(g) continuing to advance the gypsum slurry sandwiched between said face paper and said backing paper with the longitudinal recesses and lateral recesses formed thereon until the gypsum slurry is cured to a hard sheet of gypsum board, and
(h) cutting individual pieces of gypsum boards at predetermined distance intervals as said sheet advances along said conveyor belt.

22. A gypsum board as in claim 20 formed by a method comprising:
(a) advancing a face paper toward a continuous moving belt,
(b) introducing a first stream of gypsum slurry onto said advancing face paper in an amount sufficient to form a relatively thin first coating of gypsum slurry on said face paper,
(c) spreading said first stream over the said face paper to form said first coating,
(d) introducing a second stream of gypsum slurry onto said first coating, said second stream constituting the major amount of the gypsum slurry,
(e) introducing a third stream of gypsum slurry onto said combined first and second stream and spreading said third stream so as to form a relatively thin second coating of gypsum slurry,
(f) advancing the resulting slurry laminate sandwiched between said facing paper and said backing paper and pressing said laminate to a predetermined thickness,
(g) continuously advancing a tape strip in contact with said face paper to thereby form a recess along each longitudinal edge of said face paper,
(h) forming lateral recesses at spaced intervals on said face paper,
(i) forming lateral recesses at spaced intervals on said face paper, continuously advancing the gypsum slurry sandwiched between said face paper and said back paper until said gypsum slurry is cured to a hard sheet of gypsum board, and
(i) cutting individual pieces of gypsum boards at predetermined distance intervals as said sheet advances along said conveyor belt.
